(19) United States
(12) Patent Application Publication
(10) Pub. No.: US 2014/0049806 A1
(43) Pub. Date: Feb. 20, 2014

(54) Reflective display

(71) Applicants: Stephen Kitson, Bristol (GB); Adrian Geisow, Portismead (GB); Timothy Taphouse, Bristol (GB)

(72) Inventors: Stephen Kitson, Bristol (GB); Adrian Geisow, Portismead (GB); Timothy Taphouse, Bristol (GB)

(73) Assignee: Hewlett-Packard Development Company, L.P., Houston, TX (US)

(21) Appl. No.: 14/003,798

(22) PCT Filed: Mar. 7, 2011
(86) PCT No.: PCT/GB11/50441

§ 371 Date: Sep. 7, 2013

(51) Int. Cl. G02B 26/00; G02B 26/02

(52) U.S. Cl. CPC G02B 26/005; G02B 26/02; G02B 26/004
USPC 359/290

(57) ABSTRACT

A display element (10) comprises a light modulating layer (40) for absorbing light in a colour waveband, and a reflector layer (16), substantially parallel to the light modulating layer (40), for selectively reflecting light in the colour waveband, and transmitting at least some non-reflected light. One of the light modulating layer (40) and the reflector layer (16) is fixed and the other of the light modulating layer (40) and the reflector layer (16) is movable. The relative positions of the light modulating layer (40) and the reflector layer (16) can be interchanged. In a first state of the display element (10) the light modulating layer (40) is in front of the reflector layer (16) in an incident light path so as to absorb incident light in the colour waveband. In a second state of the display element (10) the reflector layer (16) is in front of the light modulating layer (40) in the incident light path so as to reflect incident light in the colour waveband.

This disclosure relates to reflective displays, including full-colour reflective displays.

A reflective display is a device formed of non-emissive display elements, in which ambient light is modulated by the display elements and reflected back to the viewer. The display elements are controlled so as to modulate light to display an image.

Since reflective displays use ambient light, a challenge is to provide a full-colour display, which reflects sufficient light to the viewer under different ambient lighting conditions.

### BRIEF DESCRIPTION OF THE DRAWINGS

FIG. 1 is a schematic diagram illustrating the principle of operation of a monochromatic display element in accordance with an example of the present disclosure;

FIG. 2A is a schematic side view of a monochromatic display element in accordance with an example of the present disclosure, in a first state;

FIG. 2B is a schematic side view of the monochromatic display element of FIG. 2A, in a second state;

FIG. 3 is a schematic side view of a colour display element in accordance with another example of the present disclosure;

FIG. 4A is a graph of absorbance versus wavelength illustrating ideal absorbance spectra of blue, green and red light absorbing layers;

FIG. 4B is a graph of absorbance versus wavelength illustrating typical absorbance spectra of blue, green and red light absorbing pigments, and

FIG. 5 is a schematic diagram of a display device implementing colour display elements in accordance with an example of the present disclosure.

### DETAILED DESCRIPTION

The present disclosure provides display elements, which may be used to form a monochromatic, polychromatic or full-colour reflective display. As will become apparent from the following description, the use of such display elements provides improvements in reflectivity and dynamic range of a display, and may provide improved colour gamut and a greater variety of design options in a colour display.

The drawings are schematic and not to scale. Like reference numerals in different drawings are used to denote the same or similar features.

### DEFINITIONS

In the following description, the term “transparent” means substantially 100% transmissive of wavelengths in and around the visible spectrum.

The term “light” means electromagnetic radiation having wavelengths in and around the visible spectrum.

References to “coloured light” or “light of a (particular) colour” means light having wavelengths within a particular colour waveband within the visible spectrum. For example, the red waveband generally corresponds to wavelengths of 580 to 650 nm, the green waveband generally corresponds to wavelengths of 490 to 580 nm and the blue waveband generally corresponds to wavelengths of 400 to 490 nm. An ideal absorber/reflector of light of a particular colour absorbs/reflects light of wavelengths only within the particular colour waveband.

The term “complementary colour” means light having wavelengths outside the particular colour waveband within the visible spectrum, which combine to appear the complementary colour. Thus, for the colour blue, the complementary colour is yellow (combined green and red wavelengths); for the colour green, the complementary colour is magenta (combined blue and red wavelengths), and for the colour red, the complementary colour is cyan (combined green and blue wavelengths).

The term “white light” means light having a spectral profile across the visible spectrum, so that it is perceived as white by the human eye. Examples of white light include ambient sunlight and light from an incandescent light source.

Terms such as “over” and “under”, “above” and “below”, “front” and “rear” are used merely to indicate the relative position of features in the incident light path as illustrated to the drawings, and do not signify the orientation of such features in a display device.

### DISPLAY ELEMENT EXAMPLES

An example reflective display element according to the present disclosure comprises a light modulator, such as a selective light absorbing layer, and a light reflector, such as a selective light reflector, substantially parallel to the light modulator. The position of the modulator relative to the reflector (or vice versa) can be changed, in order to change the state of the reflective display element.

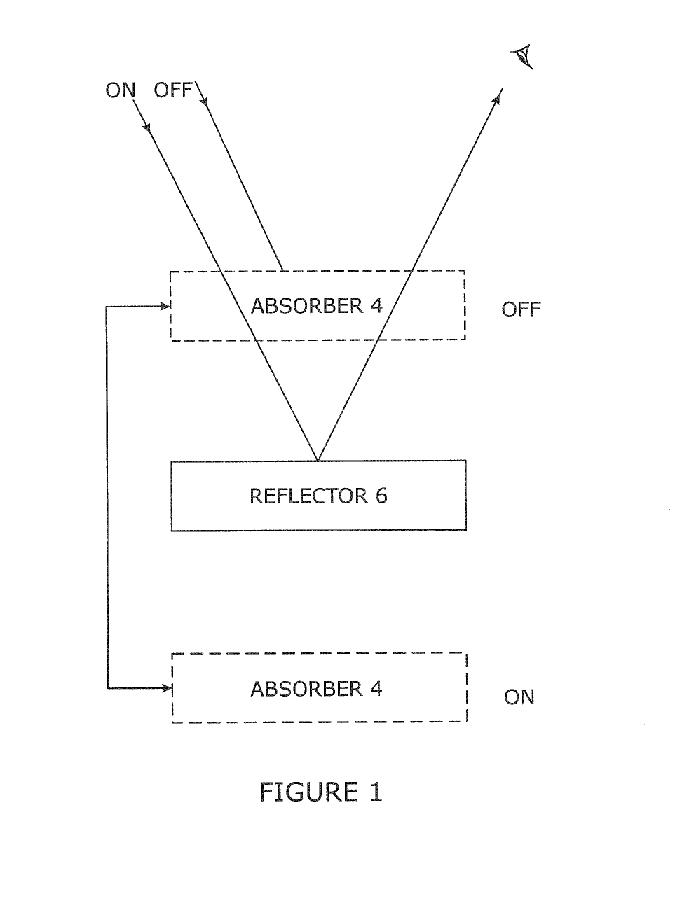

FIG. 1 illustrates an effect of changing the position of a light absorber 4, forming a light modulator, with respect to a fixed light reflector 6. For simplicity, FIG. 1 illustrates a display element for displaying a single colour, illuminated with light of the same, single colour, in which the absorber 4 is an ideal absorber (i.e., it fully absorbs all wavelengths of the single colour) and the reflector 6 is an ideal reflector (i.e., it fully reflects all wavelengths of the single colour). Example implementations include single colour display elements, and stacked arrangements including single colour display elements, as described below.

In a first state, the absorber 4 is positioned in front of (i.e., above) the reflector 6. Light of a single colour (e.g., red, green or blue), incident on the display element (i.e., from the front), is absorbed by the absorber 4 and not transmitted to the reflector 6 for reflection to a viewer. This represents an OFF or fully black state.

In a second state, the absorber 4 is positioned behind (i.e., below) the reflector 6. Light of the single colour (e.g., red, green or blue), incident on the display element (i.e., from the front), is reflected by the reflector back to the viewer and is not transmitted to the absorber 4. This represents an ON or single colour state.

In another example (not shown), the position of the light reflector may be changed (i.e., positioned above or below) relative to a fixed absorber, to change the state of the reflective display element.

In an example display element according to the present disclosure, a movable electro-optic layer such as an electrofluidic light modulator (i.e., an electrically movable light modulating fluid), is provided in combination with a fixed light reflector (e.g., a stationary, solid reflecting layer). The light modulating fluid may be electrically moved between first and second interconnected channels, which are situated above and below the reflector, respectively, and arranged substantially parallel thereto. Thus, the display element has first and second states, corresponding to the positions of the light modulating fluid in front of and behind the reflector, as described above. In addition, as described below, the display element has a plurality of intermediate states between the first and second states, in which the light modulating fluid is partially in front of the reflector and vice versa. The electrically movable light modulating fluid may take a variety of forms, for example, an electrically movable light absorbing fluid (e.g., a dispersion of a coloured pigment in a transparent fluid—herein “pigment dispersion”).

In example implementations comprising single colour display elements, a display element of a first colour has a light absorbing fluid adapted to selectively absorb light of the first colour and transmit non-absorbed light corresponding to a second colour that is complementary to the first colour, and a light reflector adapted to selectively reflect light of the first colour and transmit non-reflected light corresponding to the second colour. Thus, in a first state in which the light absorbing fluid substantially fills a first channel above the reflector, the reflector is fully concealed and the light absorbing fluid absorbs light of the first colour (fully OFF state). In a second state, in which the light absorbing fluid substantially fills a second channel beneath the reflector, the light absorbing fluid is concealed by the reflector which selectively reflects light of the first colour, and substantially none of the light of the first colour is transmitted to, and thus absorbed by, the light absorbing fluid (fully ON state).

In example implementations, a plurality of intermediate states exist between the above-mentioned first, fully OFF state and the above-mentioned second, fully ON state. In these intermediate states, the light absorbing fluid is partly in the first channel above the reflector and partly in the second channel below the reflector, so that the display element is electrically controllable to provide a range of colour intensities. For simplicity, the following description discloses example display elements according to the present disclosure, mainly with reference to the first and second states.

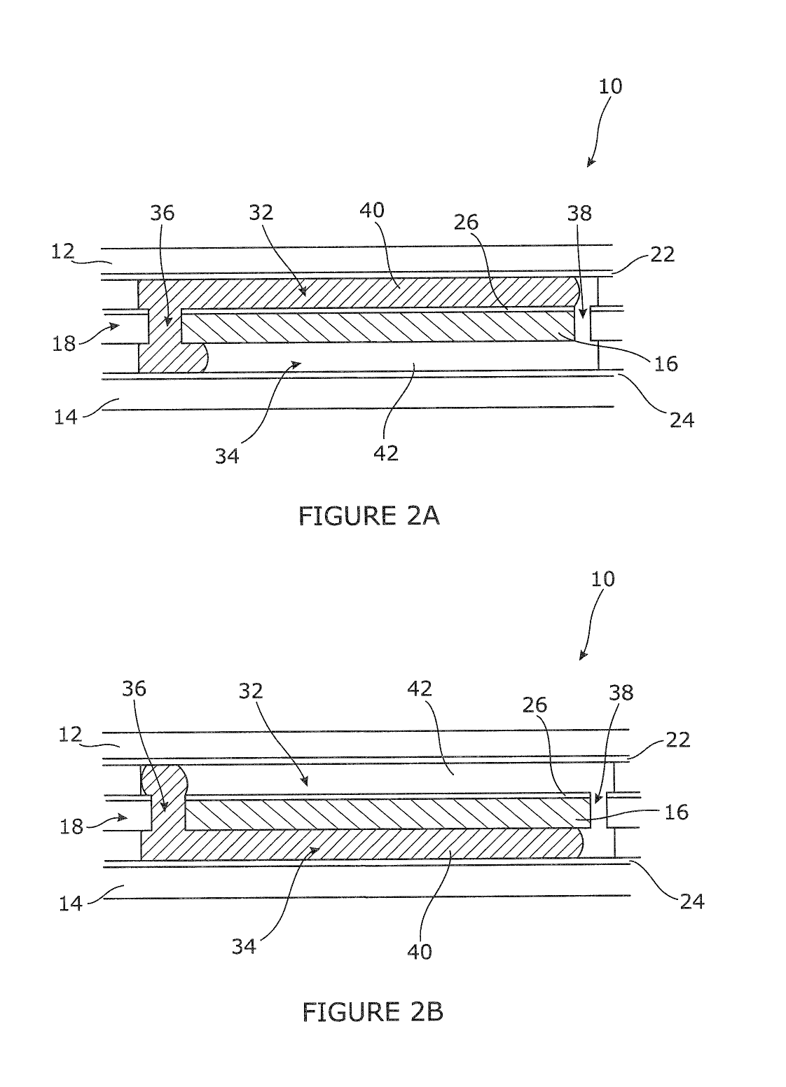

FIGS. 2A and 2B are schematic side views of an example of a monochromatic, single colour display element according to the present disclosure, in first and second states, respectively. In the illustrated example, the movable electro-optic layer is formed by an electrically movable light absorbing fluid, which may be electrically moved by electrowetting.

Display element 10 comprises a first transparent substrate 12, forming a front of the display element 10, and a second transparent substrate 14 separated from the first transparent substrate 12 to define a cavity 18 therebetween. Display element 10 further comprises a reflector layer 16 in the cavity 18, and separated from the first and second transparent substrates 12, 14. Transparent electrowetting electrodes 22 and 24 are provided on the interior surfaces of the first and second transparent substrates 12, 14, respectively, and a transparent electrode 26 is provided over the reflector layer 16.

A first channel 32 is defined in the cavity 18 above the reflector layer 16 and a second channel 34 is defined in the cavity 18 below the reflector layer 16. First and second channels 32, 34 are interconnected by one or more apertures 36, 38 through the reflector layer 16. In the illustrated example, apertures 36, 38 are provided at respective lateral ends of the display element 10.

An electrically conductive light absorbing fluid 40 (e.g., a pigment dispersion) is contained in the interconnected first and second channels 32, 34. The light absorbing fluid 40, which provides light modulation, may be moved by electrowetting, by means of electrical signals applied to transparent electrodes 22, 24, 26, to change the display element 10 between first and second states. In example implementations, a transparent electrically insulating medium 42 (e.g., a transparent oil), immiscible with the light absorbing fluid 40, also may be contained within the interconnected first and second channels 32, 34.

The reflector layer 16 is adapted to selectively reflect light of a first colour, corresponding to the colour of the display element 10, and the light absorbing fluid 40 is adapted to selectively absorb light of the first colour. In consequence, the light absorbing fluid 40 appears the complementary colour to the first colour.

In an example, the reflector layer 16 selectively reflects blue light and light absorbing fluid 40 absorbs blue light and may be referred to as a “yellow fluid” (since the light absorbing fluid does not absorb red and green, it appears yellow). In other examples, reflector layer 16 selectively reflects green light or red light and light absorbing fluid 40 absorbs green light (“magenta fluid”) or red light (“cyan fluid”), respectively.

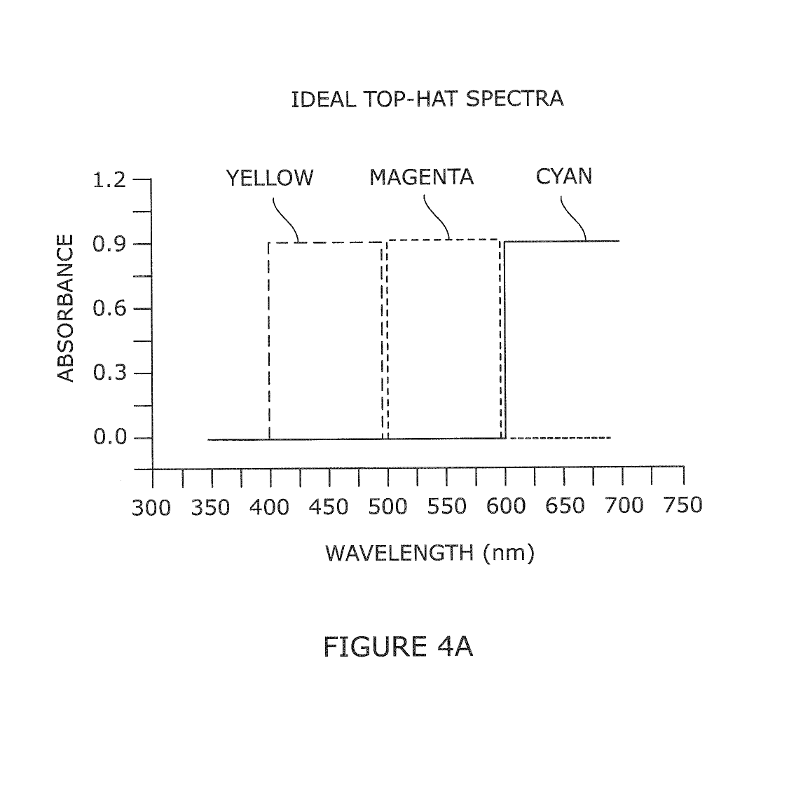

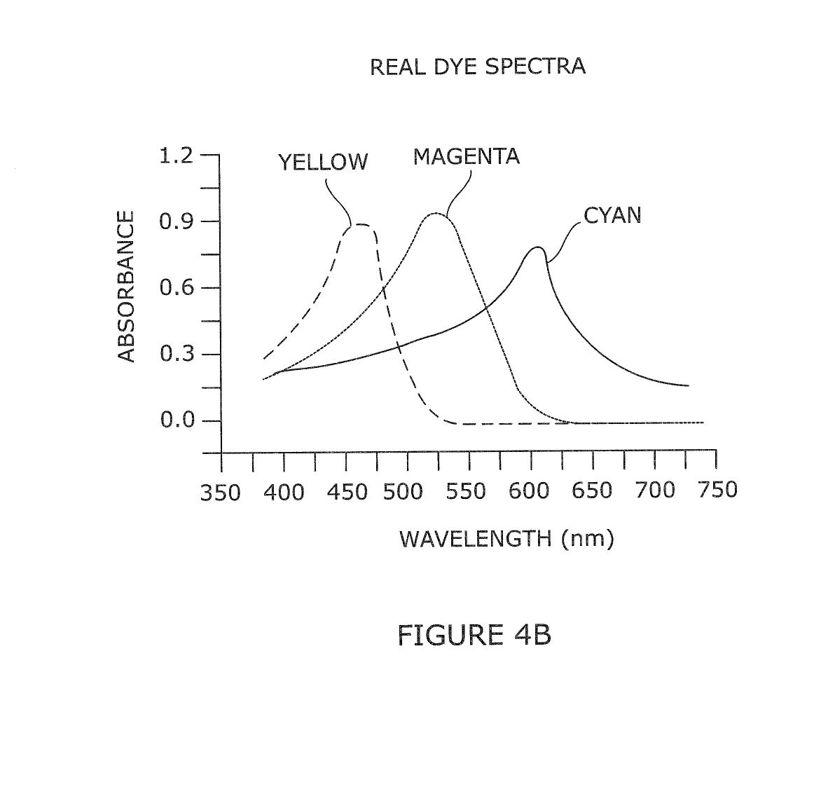

Light absorbing fluid 40 may comprise any suitable material with the property of selectively absorbing light in a particular colour waveband. Such materials comprise coloured dyes and pigments. Whilst it is desirable to use a light absorbing fluid 40 having an absorption spectrum for the particular colour as close as possible to the ideal, top-hat absorption profile for that colour, in practice the absorption profile is non-ideal. This is illustrated in FIGS. 4A and 4B, discussed further below. Thus, in an implementation, the light absorbing fluid 40 is chosen according to design requirements for the particular application, taking into account the materials and properties of the other features of the display element, such as the selective reflector 16.

Selective reflector 16 may comprise any suitable structure adapted to reflect light in a particular colour waveband. For example, selective reflector 16 may comprise a multilayer dielectric mirror comprising a stack of alternate, quarter wavelength thickness, layers of high and low refractive index materials. Selective reflector 16 may include a transparent, supporting substrate of an appropriate thickness, so as to form a dividing wall between the first and second channels 32, 34. Suitable multilayer mirrors are available through optical filter coating vendors such as Evaporated Coatings Inc of Willow Grove, Pa., USA. Other suitable colour-selective reflectors include cholesteric polymers. Whilst it is desirable to use a selective reflector 16 having a reflectance profile as close to the ideal, top-hat reflectance profile as possible, in practice the reflectance spectrum of the reflector 16 is non-ideal. Thus, in an implementation, the selective reflector 16 is chosen according to design requirements for the particular application, taking into account the materials, properties and configuration of the other features of the display element, such as light absorbing fluid 40.

In the following description of the example display element of FIGS. 2A and 2B, for ease of understanding, a light absorbing fluid 40 having a substantially ideal absorption profile, and a selective light reflector 16 having a substantially ideal reflectance profile, are assumed.

FIG. 2A illustrates the example display element in a first, fully OFF state in which the light absorbing fluid 40 is moved to substantially fill the first channel 32 above the reflector layer 16, by applying a voltage difference between electrowetting electrodes 22, 24.

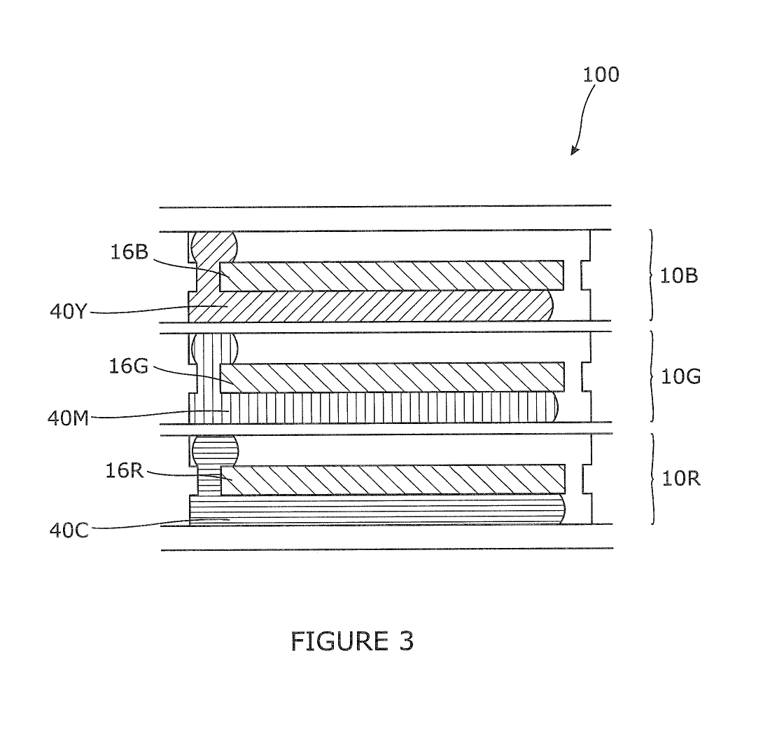

In this first state, the light absorbing fluid 40 substantially fully conceals the reflector layer 16. Ambient white light, incident on the front of the display element 10 is selectively absorbed by light absorbing fluid 40 and non-absorbed light (i.e., light of the complementary colour) is transmitted to reflector layer 16. Since reflector layer 16 selectively reflects only light of the first colour, which has already been absorbed by light absorbing fluid 40, substantially no light is reflected by reflector layer 16. Nevertheless, light of wavelengths outside the spectral range of the first colour are transmitted by the selective reflector layer 16, as discussed below in relation to FIG. 3.

FIG. 2B illustrates the example display element in a second state in which the light absorbing fluid 40 is moved to substantially fill the second channel 34 below the reflector layer 16 by applying a different voltage difference between electrowetting electrodes 22, 24.

In this second state, the reflector layer 16 is positioned in front of, and substantially fully conceals, the light absorbing fluid 40. Incident ambient light is selectively reflected by reflector layer 16 and non-reflected light (i.e., light of the complementary colour) is transmitted to light absorbing fluid 40. Light absorbing fluid 40 selectively absorbs only light of the first colour, which has already been reflected by reflector layer 16, so that substantially no light is absorbed by light absorbing fluid 40. Thus, light of wavelengths outside the spectral range of the first colour is transmitted through light absorbing fluid 40, as discussed below in relation to FIG. 3.

One suitable implementation example of the example display element of FIGS. 2A and 2B, and its associated method of operation including details of the voltages applied to change between the first and second states, is described in Applied Physics Letters 97, 143501 (2010) entitled “High Reflectivity Electrofluidic Pixels with Zero-Power Grayscale Operation” by S Yang at al.

In other examples (not shown), the light absorbing fluid 40 (or other type of electro-optic layer/light modulator) of a display element may be electrically moved to positions above and below the reflector 16 by electrophoresis, dielectrophoresis or any other suitable microfluidic phenomena. Accordingly, the nature and position of electrodes, and the electrical signals applied for electrically moving the light absorbing fluid 40, are determined according to the design of the display element, including its configuration and the technique used for electrofluidic movement.

FIG. 3 is a schematic side view of an example of a full colour display element according to the present disclosure. In the illustrated example, the colour display element 100 is formed by a stack of three monochromatic (single colour) display elements 10B, 10G, 10R, as described above with respect to FIGS. 2A and 2B. For ease of illustration, the electrowetting electrodes of the display elements 10 are not shown. The three display elements 10B, 10G, 10R (also referred to herein as “display element components”) of the stack comprise three different coloured display elements, each comprising an electro-optic layer (in the form of a light absorbing fluid) and complementary reflector combination, which together provide a full-colour display.

In a particular implementation, the example colour display element 100 comprises a front, blue display element component 10B, a middle, green display element component 10G and a rear, red display element component 10R. Blue display element component 10B comprises a yellow fluid 40Y, which selectively absorbs blue light, in combination with a reflector 16B that selectively reflects blue light (and transmits other wavelengths). Green display element component 10G comprises a magenta fluid 40M, which selectively absorbs green light, in combination with a reflector 16G that reflects green light (and transmits other wavelengths including red light). Red display element component 10R comprises a cyan fluid 40C, which selectively absorbs red light, in combination with a reflector 16R that reflects red light (which may be a selective reflector or a broadband reflector).

In other examples, a full colour display element may be formed from different combinations of colour display element components. For instance, a colour display element may be formed from three monochromatic, single colour display elements having yellow, red and black electro-optic layers with blue, green and broadband reflectors, respectively. Other example combinations are described further below.

Colour display element 100 of FIG. 3 operates as described below. For ease of understanding, in the following description it is assumed that, for each single colour display element component, the light absorbing fluid 40 has a substantially ideal absorption profile for the corresponding colour, and the selective light reflector 16 has a substantially ideal reflectance profile for the corresponding colour.

Ambient white light is incident on the front display element component 10B. In the OFF state, yellow fluid 40Y is in front of reflector 16B, so that substantially all the blue light is absorbed, and substantially no blue light is reflected by reflector 16B. Nevertheless, light of non-blue wavelengths (i.e., red and green light) is transmitted by reflector 16B through to the middle display element 10G. In the ON state, reflector 16B is in front of yellow fluid 40Y, so that substantially all the blue light is reflected, and substantially no blue light is transmitted by reflector to be absorbed by yellow fluid. Nevertheless, light of non-blue wavelengths (i.e., green and red light) is transmitted through yellow fluid 40Y to the middle display element 10G.

Accordingly, non-blue wavelengths of light are incident on the middle display element component 10G. In the OFF state, magenta fluid 40M is in front of reflector 16G, so that substantially all the green light is absorbed, and substantially no green light is reflected by reflector 16G. Nevertheless, light of non-green wavelengths (i.e., red light, since blue light is already reflected or absorbed in the front display element component 10B) is transmitted by reflector 16G through to the rear display element 10R. In the ON state, reflector 16G is in front of magenta fluid 40M, so that substantially all the green light is reflected, and substantially no green light is transmitted by reflector to be absorbed by magenta light absorbing fluid. Nevertheless, light of non-green wavelengths (i.e., red light, since blue light is already ready reflected or absorbed in the front display element components 10B) is transmitted through magenta fluid 40M to the rear display element 10R.

Accordingly, red wavelengths of light are incident on the rear display element component 10R. In the OFF state, cyan fluid 40C is in front of the reflector 16R, so that substantially all the red light is absorbed, and substantially no red light is reflected by reflector 16R. Since light of non-red wavelengths has already been reflected or absorbed in the front and middle display element components 10B and 10G, substantially no light is transmitted by the rear display element component 10R. In the ON state, reflector 16R is in front of cyan fluid 40C, so that substantially all the red light is reflected, and substantially no red light is transmitted by reflector 16R to be absorbed by cyan fluid 40C. Again, since light of non-red wavelengths has already been reflected or absorbed in the front and middle display elements 10B and 10G, substantially no light is transmitted by display element component 10R.

The above description assumes that the yellow, magenta and cyan light absorbing fluids, and the corresponding blue, green and red selective reflectors have substantially ideal spectral profiles. FIG. 4A illustrates such an ideal, top-hat absorption spectra for the yellow, magenta and cyan absorbing fluids, showing absorption of wavelengths only within the corresponding blue, green and red wavebands. The ideal reflectance spectra for selective blue, green and red selective reflectors would have a similar square or top-hat shaped profile.

In practice, colour selective light absorbing fluids/reflectors do not have ideal spectral absorption/reflectance profiles. FIG. 4B illustrates actual absorption spectra for typical yellow, magenta and cyan light absorbing fluids, showing absorption of wavelengths that overlap. In particular, the absorption profile of each of the yellow, magenta and cyan light absorbing fluids includes a tail of on the short wavelength side. Thus, the magenta light absorbing fluid absorbs some wavelengths in the blue waveband, and the cyan light absorbing fluid absorbs some wavelengths in the blue and green wavebands. In consequence, in conventional full-colour reflective displays, loss of coloured light occurs in the green waveband and, more significant loss occurs in the blue waveband due to absorption by the magenta and cyan light absorbing fluids (or equivalent light modulator/absorber).

In contrast, with the above described colour display element 100, loss of coloured light within the stack is minimized, by virtue of the ability to move the (selective) reflector in front of the corresponding selective light absorbing fluid in the incident light path. In particular, when the blue display element component 10B is turned (fully) ON, since the blue selective reflector 16B is placed in front of the yellow, magenta and cyan fluids 40Y, 40M and 40C in the path of incident light, light in the blue waveband is substantially fully reflected back to the viewer and not transmitted for absorption by the subsequent light absorbing fluids. Similarly, when the green display element component 10G is turned (fully) ON, since the green selective reflector 16G is placed in front of the magenta and cyan fluids 40M and 40C in the path of incident light in the green waveband is substantially fully reflected back to the viewer and not transmitted for absorption by the subsequent light absorbing fluids.

Thus, when one of the display element components 10B, 10G and 10R is in the (fully) ON state, substantially all incident light within its corresponding colour waveband (blue, green or red) is reflected by the corresponding selective reflector 16B, 16G and 16R, with minimal absorption by the underlying light absorbing fluids. Thus, a reflective display formed from such display elements has improved brightness, especially in the shorter wavelength (blue and green) wavebands.

In addition, the above described colour display element has an enhanced dynamic range, with a larger colour gamut, by virtue of the ability to move the light absorbing fluid of each display element (fully) behind the corresponding selective reflector and vice versa.

Moreover, by using the above described, stacked arrangement of monochromatic single colour display elements, instead of a side-by-side arrangement, a greater efficiency of utilisation of the available ambient light is achieved in a reflective display, thus enabling viewing in low level ambient lighting conditions.

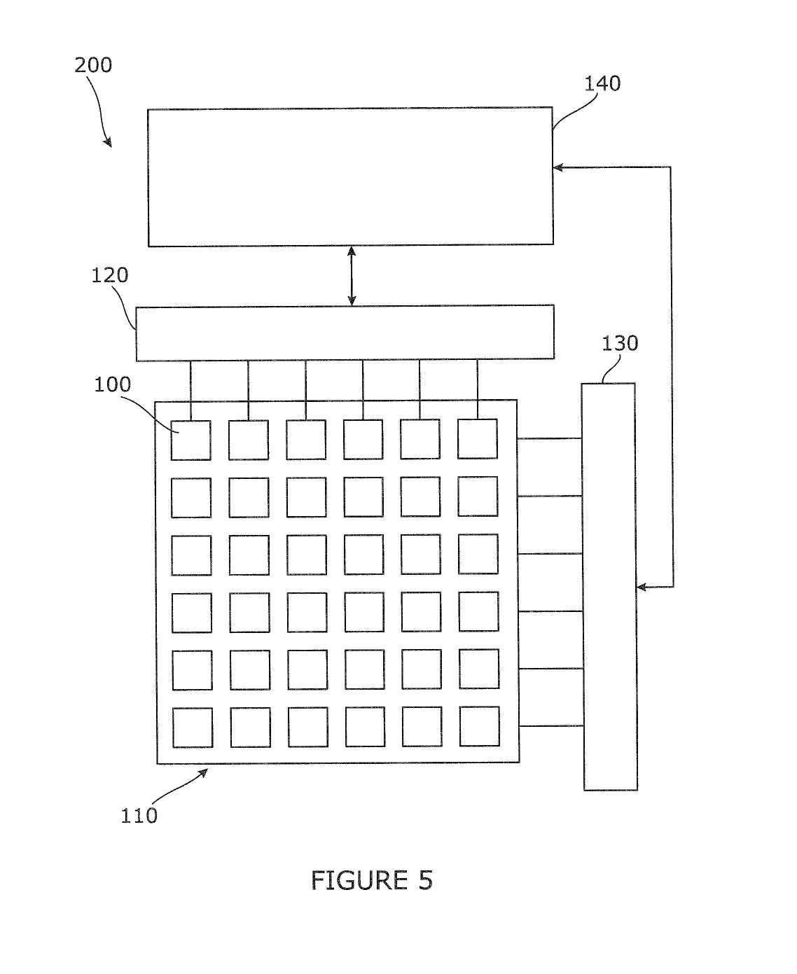

FIG. 5 schematically illustrates a display device 200 formed from an array of colour display elements 100 according to examples of the present disclosure.

Display device 200 comprises an array 110 of rows and columns of display elements 100, such as the display elements described above in relation to FIG. 3, typically fabricated with common upper and lower transparent substrates. Each display element 100 forms a colour pixel of full colour reflective display 200. Each single colour display element 10 of each colour display element 100 is independently controllable by a column driver 120 and a row driver 130. The column driver 120 and a row driver 130, under the control of a processor 140, provide electrical signals to the electrowetting electrodes (or equivalent) of each of the colour display elements 100 to control the state thereof. Thus, the state of each colour display element 100 is electrically controlled to modulate incident ambient light so as to reflect the colour for the corresponding pixel, as described above, so that the array displays a full colour image.

Alternative example display devices may be formed form an array of monochromatic, single colour display elements 10 according to examples of the present disclosure.

Thus, bright reflective displays can be formed, which are capable of showing vibrant colours using ambient illumination.

### ALTERNATIVE EXAMPLES

In the above-described examples, the electro-optic layer/light absorbing layer of a display element or display element component is movable to either side of (above or below) a fixed selective reflector layer. In other examples, the electro-optic layer/light absorbing layer may be fixed, and the selective reflector layer may be moveable to either side thereof. For example, the reflector layer may comprise reflecting particles suspended in a suitable fluid, which can be moved by electro-fluidic effects such as electrowetting, electrophoresis or dielectrophoresis.

As indicated above, a full colour display element may be formed from various different combinations of three different colour display element components. In the above described examples, a full colour display element is formed from display element components comprising: yellow, magenta and cyan coloured fluids in combination with blue, green and red/broadband (selective) reflectors, respectively; or yellow, red and black coloured fluids in combination with blue, green and broadband reflectors, respectively. Other combinations include display element components comprising: yellow, cyan and black coloured fluids in combination with blue, red and broadband reflectors, respectively; cyan, blue and black coloured fluids in combination with red, green and broadband reflectors, respectively; yellow, green and black coloured fluids in combination with blue, red and broadband reflectors, respectively. Many other colour combinations are possible, as described in co-pending International Patent Application No: PCT/U.S.2009/061627 entitled “Reflective Display Device”, assigned to the present applicant.

In addition, colour display elements may be formed with a more limited colour gamut from just two different colour display element components, such as display element components comprising two of: yellow, magenta and cyan fluids (together with complementary reflectors), or any other pair of display element components comprising different light absorbing fluids capable of modulating substantially the entire visible spectrum, such as a pair of display element components with cyan and red fluids, respectively.

Whilst the display examples concern a reflective display, display element examples according to the present disclosure may be implemented in displays incorporating light sources, such as a front or side light, to provide illumination in the absence of adequate ambient light.

Various modifications and changes can be made to the described and illustrated examples, consistent with the present disclosure. Accordingly, the examples should not be regarded as limiting the scope of the present disclosure, which is defined in the accompanying claims.

1. A display element comprising:
a light modulating layer for absorbing light in a colour waveband, and
a reflector layer, substantially parallel to the light modulating layer, for selectively reflecting light in the colour waveband, and transmitting at least some non-reflected light;
wherein one of the light modulating layer and the reflector layer is fixed and the other of the light modulating layer and the reflector layer is movable, and wherein the relative positions of the light modulating layer and the reflector layer can be interchanged such that in a first state of the display element the light modulating layer is in front of the reflector layer in an incident light path so as to absorb incident light in the colour waveband, and in a second state of the display element the reflector layer is in front of the light modulating layer in the incident light path so as to reflect incident light in the colour waveband.

2. A display element as claimed in claim 1, having a plurality of intermediate states between the first state and the second state in which the reflector layer is partially in front of the light modulating layer and vice versa.

3. A display element as claimed in claim 1 or claim 2, wherein the light modulating layer is an electro-optic fluid, electrically movable between a first channel on a front side of the reflector layer and an interconnected second channel on the rear side of the reflector layer.

4. A display element as claimed in claim 3, wherein the electro-optic fluid is movable by one of: electrowetting, electrophoresis and dielectrophoresis.

5. A display element as claimed in claim 1, 2 or 3, wherein the electro-optic fluid is a selective light absorbing fluid.

6. A display element as claimed in any one of claims 1 to 5, wherein the reflector layer comprises a multilayer stack or a cholesteric polymer layer, adapted to selectively reflect light in the colour waveband.

7. A display element as claimed in claim 1, wherein the reflector layer is an electro-optic fluid, electrically movable between a first channel on a front side of the light modulating layer and an interconnected second channel on the rear side of the light modulating layer.

8. A display element comprising a plurality of stacked display element components, each display element component comprising a display element as claimed in any one of claims 1 to 7, and wherein each display element component has a light modulating layer for absorbing light in a different colour waveband.

9. A display element having a front side for illumination by incident light, the display element comprising:
a first display element component at the front side of the display element, the first display element comprising:
a first light modulating layer for absorbing light in a first colour waveband, and
a first reflector layer, substantially parallel to the first light modulating layer, for selectively reflecting light in the first colour waveband, and transmitting at least some non-reflected light;
wherein one of the first light modulating layer and the first reflector layer is fixed and the other of the first light modulating layer and the first reflector layer is movable, and wherein the relative positions of the first light modulating layer and the first reflector layer can be interchanged such that in a first state, the first light modulating layer is in front of the first reflective layer in the incident light path so as to absorb incident light in the first colour waveband, and in a second state, the first reflective layer is in front of the first light modulating layer in the incident light path so as to reflect incident light in the first colour waveband; and
a second display element component behind the first display element component, for receiving light transmitted by the first display element component, the second display element component comprising:
a second light modulating layer for absorbing light in a second colour waveband different from the first colour waveband, and
a second reflector layer, substantially parallel to the second light modulating layer, for reflecting light at least in the second colour waveband;
wherein one of the second light modulating layer and the second reflector layer is fixed and the other of the second light modulating layer and the second reflector layer is movable, and wherein the relative positions of the second light modulating layer and the second reflector layer can be interchanged such that in a first state, the second light modulating layer is in front of the second reflective layer in the incident light path so as to absorb incident light in the second colour waveband, and in a second state, the second reflective layer is in front of the second light modulating layer in the incident light path so as to reflect incident light in the second colour waveband.

10. A display element as claimed in claim 9, the second reflector layer for transmitting at least some non-reflected light, the display element further comprising:
a third display element component behind the second display element component for receiving light transmitted by the second display element component, the third display element component comprising:
a third light modulating layer for absorbing light in a third colour waveband different from the first and/or second colour wavebands, and
a third reflector layer, substantially parallel to the third light modulating layer, for reflecting light in at least the third colour waveband;
wherein one of the third light modulating layer and the third reflector layer is fixed and the other of the third light modulating layer and the third reflector layer is movable, and wherein the relative positions of the third light modulating layer and the third reflector layer can be interchanged such that in a first state, the third light modulating layer is in front of the third reflective layer so as to absorb incident light in the third colour waveband, and in a second state, the third reflective layer is in front of the third light modulating layer in the incident light path so as to reflect incident light in the third colour waveband.

11. A display element as claimed in claim 10, wherein:
the first colour waveband is blue; the second colour waveband is green, and the third colour waveband is red, or
the first colour waveband is blue; the second colour waveband is cyan corresponding to green and blue wavebands, and the third colour waveband white corresponding to broadband visible spectrum.

12. A reflective display device comprising:
an array of display elements as claimed in any preceding claim, and
driver circuitry to control the state of the display elements in order to display images.

13. A reflective display device comprising:
an array of display elements, each display element comprising:
a first display element component at a front side of the display element, the first display element comprising:
a first light modulating layer for absorbing light in a first colour waveband, and
a first reflector layer, substantially parallel to the first light modulating layer, for selectively reflecting light in the first colour waveband, and transmitting at least some non-reflected light;
wherein one of the first light modulating layer and the first reflector layer is fixed and the other of the first light modulating layer and the first reflector layer is movable, and wherein the relative positions of the first light modulating layer and the first reflector layer can be interchanged such that in a first state, the first light modulating layer is in front of the first reflective layer in the incident light path so as to absorb incident light in the first colour waveband, and in a second state, the first reflective layer is in front of the first light modulating layer in the incident light path so as to reflect incident light in the first colour waveband; and
a second display element component behind the first display element component, for receiving light transmitted by the first display element component, the second display element component comprising:
a second light modulating layer for absorbing light in a second colour waveband different from the first colour waveband, and
a second reflector layer, substantially parallel to the second light modulating layer, for reflecting light at least in the second colour waveband;
wherein one of the second light modulating layer and the second reflector layer is fixed and the other of the second light modulating layer and the second reflector layer is movable, and wherein the relative positions of the second light modulating layer and the second reflector layer can be interchanged such that in a first state, the second light modulating layer is in front of the second reflective layer in the incident light path so as to absorb incident light in the second colour waveband, and in a second state, the second reflective layer is in front of the second light modulating layer in the incident light path so as to reflect incident light in the second colour waveband.

14. A display device as claimed in claim 13, the second reflector layer of each display element for transmitting at least some non-reflected light, wherein each display element further comprises:
a third display element component behind the second display element component for receiving light transmitted by the second display element component, the third display element component comprising:
a third light modulating layer for absorbing light in a third colour waveband different from the first and/or second colour wavebands, and
a third reflector layer, substantially parallel to the third light modulating layer, for reflecting light at least in the third colour waveband;
wherein one of the third light modulating layer and the third reflector layer is fixed and the other of the third light modulating layer and the third reflector layer is movable, and wherein the relative positions of the third light modulating layer and the third reflector layer can be interchanged such that in a first state, the third light modulating layer is in front of the third reflective layer so as to absorb incident light in the third colour waveband, and in a second state, the third reflective layer is in front of the third light modulating layer in the incident light path so as to reflect incident light in the third colour waveband.

15. A display device as claimed in claim 14, wherein:
the first colour waveband is blue; the second colour waveband is green, and the third colour waveband is red, or
the first colour waveband is blue; the second colour waveband is cyan corresponding to green faster and blue wavebands, and the third colour waveband is white corresponding to broadband visible spectrum.
